(19) United States
(12) Patent Application Publication
(10) Pub. No.: US 2017/0357947 A1
(43) Pub. Date: Dec. 14, 2017

(54) MEETING ATTENDANCE TRACKING SYSTEM

(71) Applicant: Intel Corporation, Santa Clara, CA (US)

(72) Inventors: Gili Ilan, Hertzeliya (IL); Tal Marian, Tel Aviv (IL)

(21) Appl. No.: 15/180,986

(22) Filed: Jun. 13, 2016

(51) Int. Cl. G06Q 10/10; H04W 4/04; G08B 21/24

(52) U.S. Cl. CPC G06Q 10/1095; G08B 21/24; H04W 4/04

(57) ABSTRACT

Various systems and methods for providing a meeting attendance tracking system are provided herein. A meeting attendance tracking system includes an indoor positioning service coupled to a plurality of radio transmitters, and operable to determine a location of a user device, the user device associated with a user, the location of the user device corresponding with a location of the user; a database interface to: access a database of scheduled events for the user; and determine a current event from the database of scheduled events, the current event corresponding with a current time and date; and a scheduler coupled to the indoor positioning service and the database interface, to: determine that the location of the user device does not correspond with a location of the current event; determine whether the user is attending a conflicting event; and provide a notification to the user or a meeting organizer regarding the current event.

### TECHNICAL FIELD

Embodiments described herein generally relate to networking and in particular, to a meeting attendance tracking system.

### BACKGROUND

In a busy corporate world people are often involved in several meetings throughout a given business day. Meeting attendance is paramount to maintain business and operational efficiency. Various techniques may be used by a meeting organizer to increase the number of meeting attendees.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic diagram illustrating an example operating environment, according to an embodiment;

FIG. 2 is a block diagram illustrating a meeting attendance management system, according to an embodiment;

FIG. 3 is a flowchart illustrating control and data flow of a meeting attendance management system, according to an embodiment;

FIG. 4 is a block diagram illustrating a meeting attendance tracking system, according to an embodiment;

FIG. 5 is a flowchart illustrating a method for providing a meeting attendance tracking system, according to an embodiment; and

FIG. 6 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Disclosed herein are systems and methods that provide a meeting attendance tracking system. With the emergence of mobile and wearable devices, new functionality has become more readily available. Many devices include sophisticated processors, radios, and other circuitry that provide notifications, location tracking, and near real time communications. Such functionality may be leveraged to improve meeting attendance for a particular user, meeting attendance tracking for a meeting organizer, or rescheduling for an attendee or organizer. Using indoor location services, a user is able to determine whether a person is currently attending a meeting, which meeting the person is attending, whether the person is late to a meeting and his estimated time of arrival (ETA), and whether the person left a scheduled meeting earlier than planned

Using enhanced indoor location services, the meeting attendance tracking system is able to determine various situations, such as when a person is at their desk instead of proceeding to a conference room. Integration with a scheduling application allows the system to determine whether conflicts exist on a person's schedule, select a new appointment time, and dynamically reschedule a person's meeting. Additionally, the system is able to determine when a person has left a meeting early, or when a meeting has ended early, and either automatically or interactively arrange a meeting in the newly available time in the person's schedule.

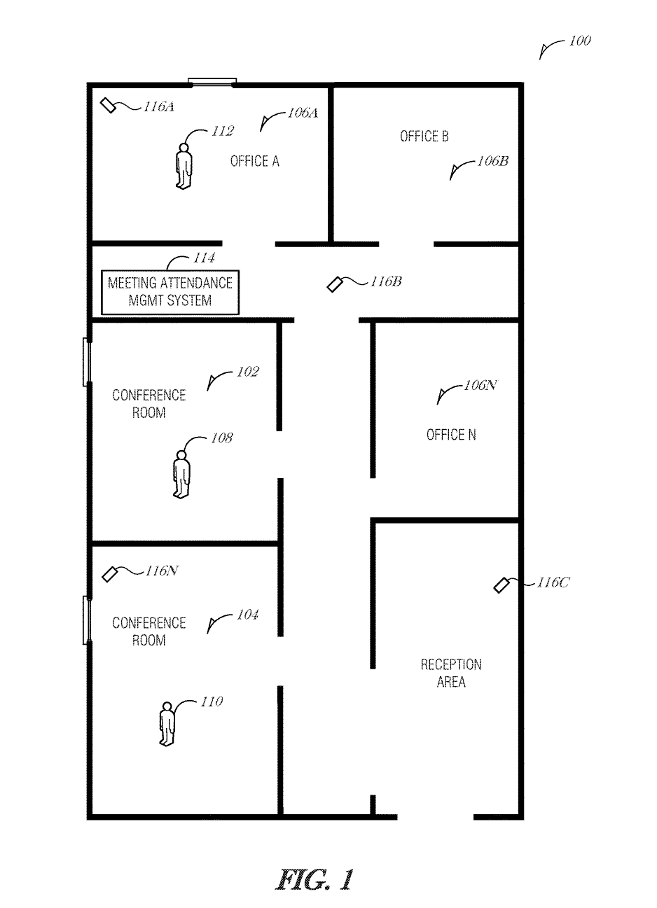

FIG. 1 is a schematic diagram illustrating an example operating environment 100, according to an embodiment. The environment 100 illustrated in FIG. 1 is of an office building setting. It is understood that the system may be implemented in other environments, such as in a factory, hospital, government center, sports arena, or the like. The environment 100 is one where people congregate for meetings, conferences, or other group-oriented activities.

The environment 100 includes a first conference room 102 and a second conference room 104. In addition, the environment includes a number offices 106A-N. A first user 108 is attending a meeting in the first conference room 102. A second user 110 is attending a meeting in the second conference room 104. A third user 112 is in an office 106A at her desk. A meeting attendance management system 114 is located in the environment 100, such as in a server room, a computer lab, or the like. The meeting attendance management system 114 may be located on-site (e.g., inside of the office building) or off-site, for example, hosted in a cloud-based server environment. The meeting attendance management system 114 may be hosted at a user's computer, for example, a desktop system, a laptop, a mobile device, or the like.

The environment 100 may include various radio location points 116A-N. The radio location points 116A-N may include Wi-Fi access points, for example, installed around the environment 100 to provide full coverage for wireless networking within the environment 100. Alternatively, the radio location points 116A-N may include Bluetooth beacons. Using signals received at a user device from the radio location points 116A-N, the user device is able to locate itself within the environment. The user device may then communicate with the meeting attendance management system 114 to report its location. Client devices, user devices, or mobile devices may be any type of compute device including, but not limited to a smartphone, a laptop, a hybrid computer, a tablet, a phablet, a smartwatch, a fob, a token, or other similar suitable devices that are able to communicate over wireless communication networks with the radio location points 116A-N and the meeting attendance management system 114.

To enable indoor positioning, for example, the environment 100 may use a Wi-Fi based positioning system (WPS), a beaconing system (e.g., using Bluetooth), magnetic positioning, dead reckoning, or another technology or technique.

WPS is a localization technique that utilizes wireless access points. A receiver device (e.g., a smartphone) is able to measure the intensity of the received signals from the access points and establish a fingerprint of various geographical positions within the environment 100. The scans may record the signal strength using such measurements as received signal strength indication (RSSI), reference signal receive power (RSRP), reference signal receive quality (RSRQ), or the like. Because the wireless signals are attenuated, dispersed, or otherwise interfered with by the interior walls, windows, and other object, each position within the environment 100 may have a relatively unique wireless signature from the multiple access points available the respective positions. As such, the scan results in a wireless signal fingerprint. After the environment 100 has been mapped with received signal strength fingerprints, the meeting attendance management system 114 may refer to the database of mapped areas and based on information from a device in a particular location in the environment 100, determine where the device is based on the wireless signal fingerprint.

Another mechanism for indoor positioning using Wi-Fi signals is to measure signal strength at a client device to several different access points. The signal strengths are then used in a propagation model to determine the approximate distance from the client device to each of the access points. Using methods of trilateration (or multilateration), the client device is able to determine its position.

Alternatively, using a Bluetooth beaconing system, the environment 100 may be outfitted with a number of Bluetooth beacons. Bluetooth beacons are low-power devices that transmit a universally unique identifier (UUID). The UUID may be received by a mobile device or an app executing on a mobile device. Based on Bluetooth signals, the receiving device is able to determine its position from signals received from several beacons.

It is understood that other indoor positioning techniques may be used, such as angle of arrival methods, micro or mini-geofence-based techniques, or the like.

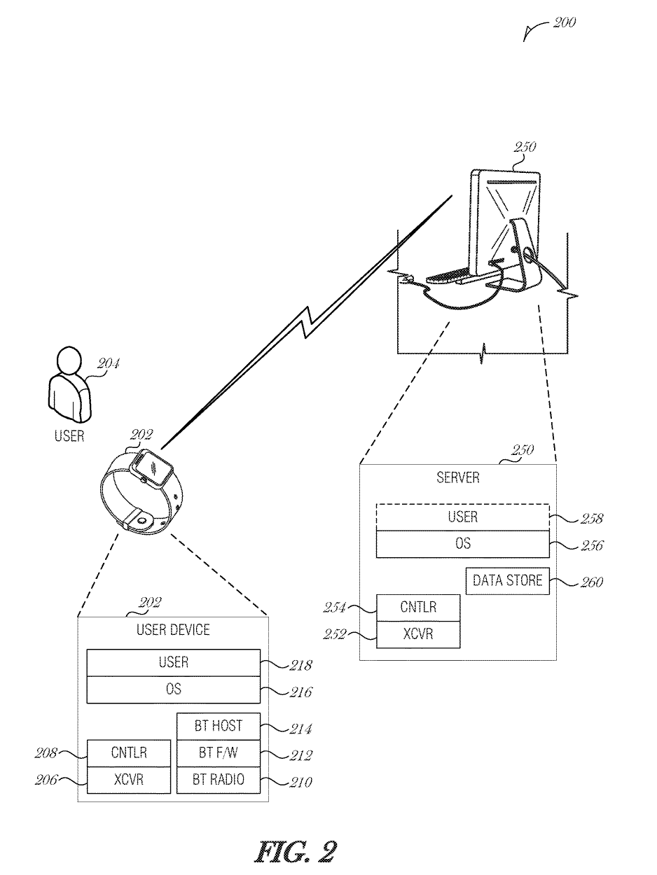

FIG. 2 is a block diagram illustrating a meeting attendance management system 200, according to an embodiment. The meeting attendance management system 200 may include a user device 202 and a server 250. The meeting attendance management system 200 may be installed and executed at a local site, such as at an office or hospital, or installed and executed from a remote site, such as a data center or a cloud service. Portions of the meeting attendance management system 200 may run locally while other portions may run remotely (with respect to the local elements).

The user device 202 may be any type of device, including but not limited to a laptop, smartphone, wearable device, tablet, hybrid device, or the like. The user device 202 includes a transceiver 206, capable of both sending and receiving data, and which is controlled by controller 208. The transceiver 206 and controller 208 may be used to communicate over various wireless networks, such as a Wi-Fi network (e.g., according to the IEEE 802.11 family of standards), cellular network, such as a network designed according to the Long-Term Evolution (LTE), LTE-Advanced, 5G or Global System for Mobile Communications (GSM) families of standards, or the like.

The user device 202 may include Bluetooth hardware, firmware, and software to enable Bluetooth connectivity according to the IEEE 802.15 family of standards. In an example, the user device 202 includes a Bluetooth radio 210 controlled by Bluetooth firmware 212 and Bluetooth host 214.

Operating system 216 interfaces with the controller 208 and Bluetooth host 214. Operating system 216 may be a desktop operating system, embedded operating system, real-time operating system, proprietary operating system, network operating system, and the like. Examples include, but are not limited to Windows® NT (and its variants), Windows® Mobile, Windows® Embedded, Mac OS®, Apple iOS, Apple WatchOS®, UNIX, Android™, JavaOS, Symbian OS, Linux, and other suitable operating system platforms.

A communication controller (not shown) may be implemented in hardware, firmware, or in the operating system 216. The communication controller may act as an interface with various hardware abstraction layer (HAL) interface, such as device drivers, communication protocol stacks, libraries, and the like. The communication controller is operable to receive user input (e.g., from a system event or by an express system call to the communication controller), and interact with one or more lower-level communication devices (e.g., Bluetooth radio, Wi-Fi radio, cellular radio, etc.) based on the user input. The communication controller may be implemented, at least in part, in a user-level application that makes calls to one or more libraries, device interfaces, or the like in the operating system 216, to cause communication devices to operate in a certain manner.

A user application space 218 on the user device 202 is used to implement user-level applications, controls, user interfaces, and the like, for a user 204 to control the user device 202. An application, app, extension, control panel, or other user-level executable software program may be used to control access to the user device 202. For example, an executable file, such as an app, may be installed on the user device 202 and operable to communicate with a host application installed on a server 250.

The server 250 may include an operating system, file system, database connectivity, radios, or other interfaces to provide an attendance tracking system to the user device 202. In particular the server 250 may include, or be communicatively connected to, a radio transceiver 252 to communicate with the user device 202. A respective controller 254 may control the transceiver 252 of the server 250, which in turn is connected with and controlled via an operating system 256 and user-level applications 258.

In operation, the user 204 is able to schedule one or more meetings. The details of the meetings are stored at the server 250. The details include the meeting time, place, attendees, description of the meeting, and the like. Attendees may have various statuses, such as required attendees or optional attendees. The server 250 may store the meeting details in data store 260. The data store 260 may be located at the server 250 or at a remote server (e.g., a database server). The server 250 may provide a reminder to the user 204 about the scheduled meeting, such as with a notification or other mechanism The server 250 may also receive location information from the user device 202, which may be transmitted on a recurring or periodic basis, on demand, or by other means. The location information may be used by the server 250 to determine the location of the user device 202 and inferentially the location of the user 204 of the user device 202. Based on the location information, the server 250 may determine that the user 204 is not at a scheduled meeting, is attending a different meeting, or other aspects or details of the user's status. Further details are provided in the following figures and description.

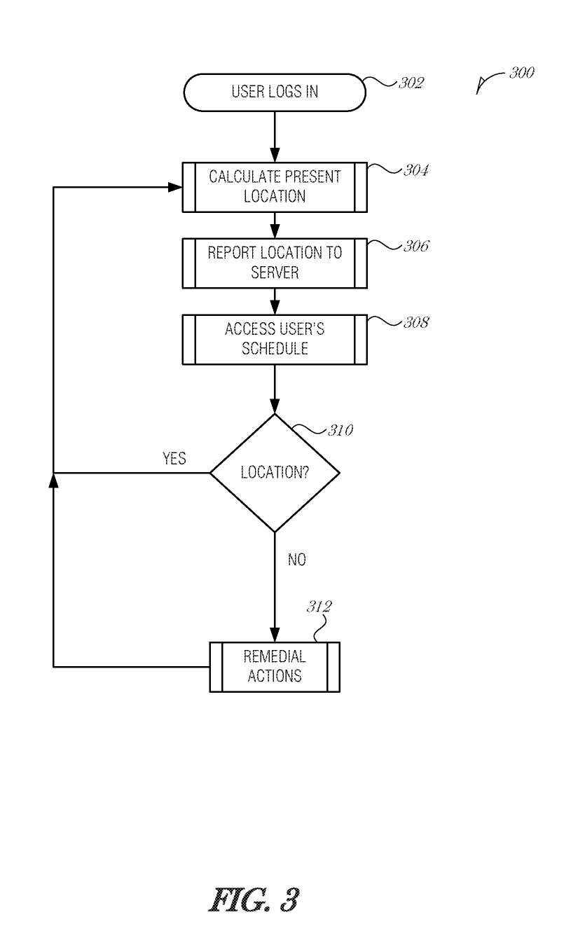

FIG. 3 is a flowchart illustrating control and data flow of a meeting attendance management system, according to an embodiment. A user logs into to a user device, such as a smartphone (operation 302). The user device includes one or more radios and other logic to determine a location of the user and the user device in an environment. The user device calculates a present location (operation 304) and reports its location to a server (operation 306). The calculation and reporting (operations 304 and 306) may be performed at regular intervals (e.g., every two minutes), when requested by the server, when triggered by the user, or triggered in other ways, such as with a motion detection system in the user device. The reporting intervals, triggering actions, or other configurations may be managed by the user, an administrative user, or the user device.

The user device is able to access the user's schedule (operation 308). Comparing the user's schedule and the user's current location, the user device is then able to determine whether the user is at a location that corresponds with the scheduled event (operation 310). For example, the user device may determine whether the user is at a scheduled meeting in a particular conference room.

Some or all of the calculations or determinations performed in operations 308 and 310 may be performed remote from the user device, such as at a server system.

If the user is at a location that corresponds with the expected location (e.g., that corresponds with a conference room of a scheduled meeting), then the data flow continues monitoring the user's location at operation 304.

If the user is not at the expected location, then one or more remedial actions may be performed at operation 312. Remedial actions include operations such as querying the user for their current status and reporting the user's response to a meeting organizer; tracking the user's movement around a facility, and based on the movement, determining an estimated time of arrival of the user to the scheduled event; or determining that a user is free from a previous scheduled event and scheduling or rescheduling an event in the newly-available free time.

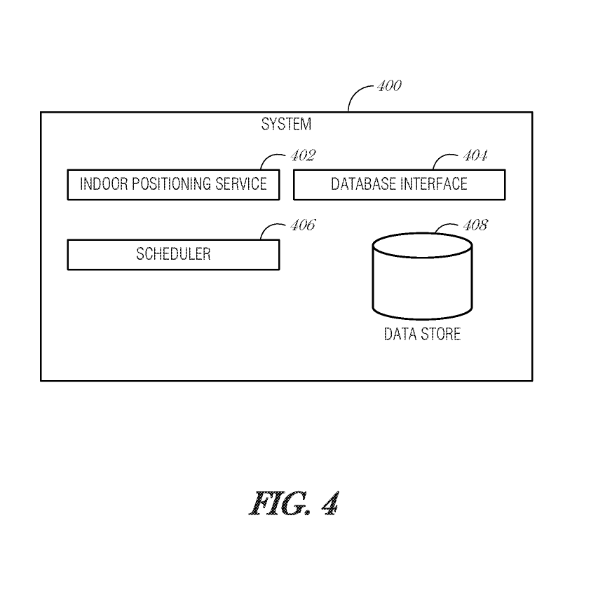

FIG. 4 is a block diagram illustrating a meeting attendance tracking system 400, according to an embodiment. The system 400 includes an indoor positioning service 402, a database interface 404, and a scheduler 406. The database interface 404 is used to access a data store 408, which may be co-located with the system 400 or remote from the system 400.

The indoor positioning service 402, database interface 404, scheduler 406, and supplemental location service are understood to encompass tangible entities that are physically constructed, specifically configured (e.g., hardwired), or temporarily (e.g., transitorily) configured (e.g., programmed) to operate in a specified manner or to perform part or all of any operations described herein. Such tangible entitles may be constructed using one or more circuits, such as with dedicated hardware (e.g., field programmable gate arrays (FPGAs), logic gates, graphics processing unit (GPU), a digital signal processor (DSP), etc.). As such, the tangible entities described herein may be referred to as circuits, circuitry, processor units, subsystems, or the like.

The indoor positioning service 402 may be coupled to a plurality of radio transmitters, and operable to determine a location of a user device, the user device associated with a user, the location of the user device corresponding with a location of the user.

In an embodiment, the indoor positioning service implements a wireless network-based technique. In a further embodiment, the wireless network-based technique includes a wireless signal fingerprint technique. In a related embodiment, the wireless network-based technique includes a trilateration calculated on signal strengths of a plurality of wireless network transmitters. In another embodiment, the wireless network-based technique includes a beaconing technique. In a related embodiment, the beaconing technique includes Bluetooth beaconing.

The database interface 404 may be configured to access a database of scheduled events for the user and determine a current event from the database of scheduled events, the current event corresponding with a current time and date.

The scheduler 406 is coupled to the indoor positioning service and the database interface, and configured to determine that the location of the user device does not correspond with a location of the current event, determine whether the user is attending a conflicting event, and provide a notification to the user or a meeting organizer regarding the current event.

In an embodiment, to determine whether the user is attending the conflicting event, the scheduler 406 is to determine a second event from the database of scheduled events and determine that the location of the user device corresponds with a location of the second event.

In an embodiment, the determination of whether the user is attending the conflicting event is negative, and the scheduler 406 is to determine that the current event has concluded with a period of remaining time, determine that the user is free from any other scheduled event during the period of remaining time, and schedule a new event during the period of remaining time. In a further embodiment, to determine that the current event has concluded, the scheduler 406 is to interface with the indoor positioning service 402 and determine that a location of an attendee from the current event, other than the user, does not correspond with the location of the current event after the location of the attendee had previously corresponded with the location of the current event.

In a further embodiment, to schedule the new event, the scheduler 406 is to identify the new event from the database of scheduled events, where the new event has a duration less than or equal to an amount of free time the user has before a next scheduled event and tentatively schedule the new event before the next scheduled event.

In an embodiment, the determination of whether the user is attending the conflicting event is negative, and in such an embodiment, the scheduler 406 is to reschedule the current event.

In an embodiment, the system 400 includes a supplemental location service to use a second technique to the indoor positioning service to determine the location of the user device. In a further embodiment, to use the second technique, the supplemental location service is to implement a device-to-device network to identify a second possible location of the user device and validate the location of the user device with the second possible location of the user device. In yet another embodiment, the device-to-device network includes a mesh network of the user device and at least one other user device, the at least one other user device communicatively connected to the server system and able to provide a proximity indication of the user device.

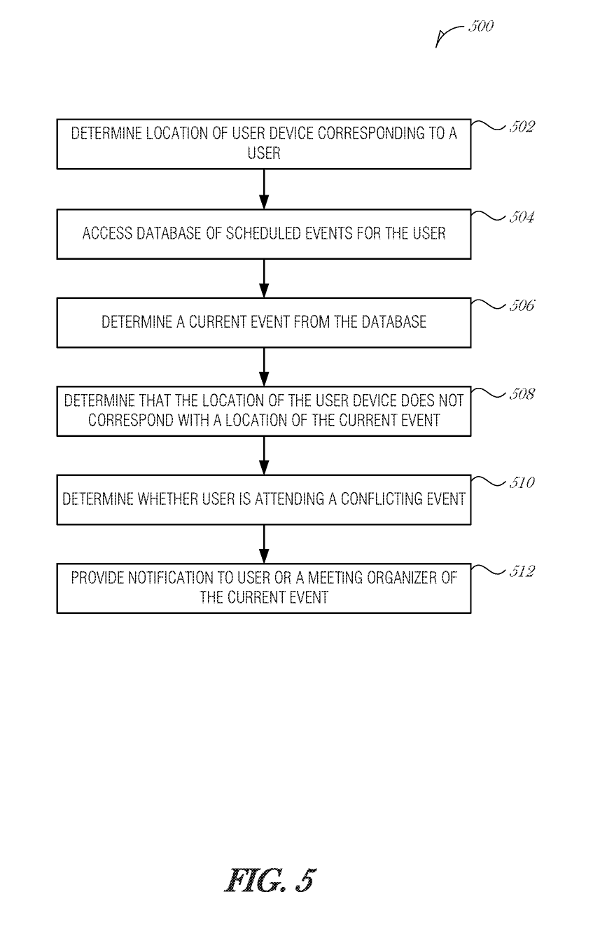

FIG. 5 is a flowchart illustrating a method 500 for providing a meeting attendance tracking system, according to an embodiment. At block 502, a server system implementing an indoor positioning technique determines a location of a user device, where the user device is associated with a user, and where the location of the user device corresponds with a location of the user.

In an embodiment, the indoor positioning technique includes a wireless network-based technique. In a further embodiment, the wireless network-based technique includes a wireless signal fingerprint technique. In a related embodiment, the wireless network-based technique includes a trilateration calculated on signal strengths of a plurality of wireless network transmitters. In a related embodiment, the wireless network-based technique includes a beaconing technique. In a further embodiment, the beaconing technique includes Bluetooth beaconing.

At block 504, a database of scheduled events for the user is accessed.

At block 506, a current event from the database of scheduled events is determined, where the current event corresponds with a current time and date.

At block 508, it is determined that the location of the user device does not correspond with a location of the current event.

At block 510, it is determined whether the user is attending a conflicting event.

In an embodiment, determining whether the user is attending the conflicting event comprises determining a second event from the database of scheduled events and determining that the location of the user device corresponds with a location of the second event. For example, the user may be located in a different conference room than that of the current event, in her office, in the bathroom, or offsite.

In an embodiment, the determination of whether the user is attending the conflicting event is negative, and in such an embodiment, the method may include determining that the current event has concluded with a period of remaining time, determining that the user is free from any other scheduled event during the period of remaining time; and scheduling a new event during the period of remaining time. In this way, the user's time is more efficiently scheduled.

Determining that the current event has concluded may be performed in a variety of ways, such as determining that attendees have left the location of the current event, determining that a conference call that was associated with the current event has ended, determining that the conference room is empty, and the like. In an embodiment, determining that the current event has concluded comprises determining that a location of an attendee from the current event, other than the user, does not correspond with the location of the current event after the location of the attendee had previously corresponded with the location of the current event.

In an embodiment, scheduling the new event comprises identifying the new event from the database of scheduled events, where the new event has a duration less than or equal to an amount of free time the user has before a next scheduled event and tentatively scheduling the new event before the next scheduled event.

In an embodiment, the determination of whether the user is attending the conflicting event is negative, and in such an embodiment, the method 400 may include rescheduling the current event. For example, the meeting attendance tracking system may determine a future time where the attendees of the current event are free based on the schedules of the attendees, and transmit a meeting invitation corresponding with the future time.

At block 512, a notification is provided to the user or a meeting organizer regarding the current event. Notifications may be in various forms, such as a text message, an alert window, a message on a notification screen, an email, a voice call, or the like. The notification may be used to notify the user that she is missing a meeting, that the meeting has been rescheduled on her behalf, of a newly proposed meeting time to reschedule, of a new meeting scheduled in the free time available after the current meeting has ended, or of other events or situations as described in this document.

In an embodiment, the method 400 includes using a second technique to the indoor positioning technique to determine the location of the user device. The second technique may be another indoor positioning technique. Alternatively, the second technique may be a mesh networking-based technique where other user devices are queried or provide information about the user device to determine an approximate location of the user device. Thus, in an embodiment, using the second technique comprises implementing a device-to-device network to identify a second possible location of the user device and validating the location of the user device with the second possible location of the user device. In a further embodiment, the device-to-device network includes a mesh network of the user device and at least one other user device, the at least one other user device communicatively connected to the server system and able to provide a proximity indication of the user device.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

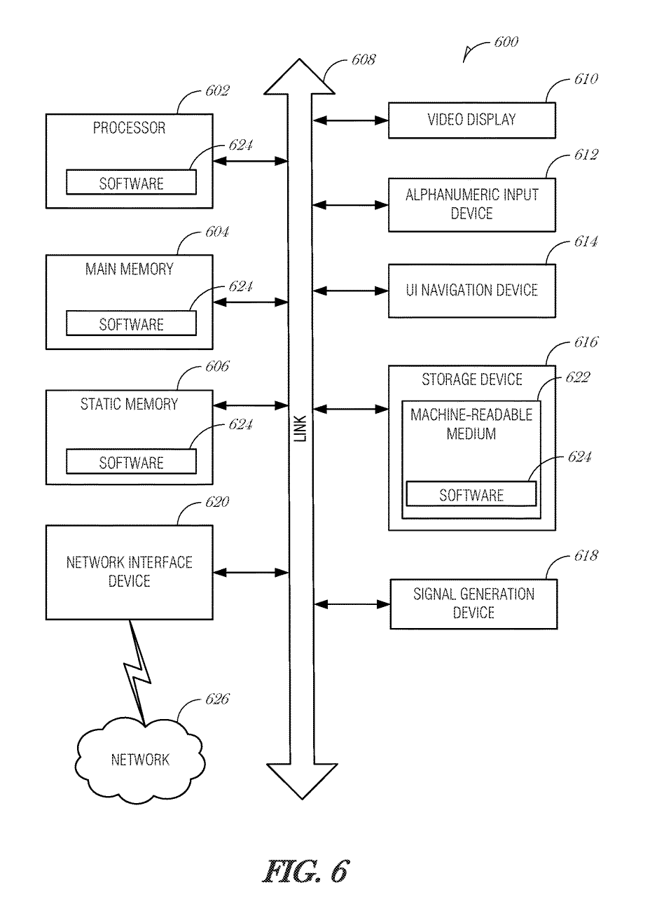

FIG. 6 is a block diagram illustrating a machine in the example form of a computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, gyrometer, magnetometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a meeting attendance tracking system, the system comprising: an indoor positioning service coupled to a plurality of radio transmitters, and operable to determine a location of a user device, the user device associated with a user, the location of the user device corresponding with a location of the user; a database interface to: access a database of scheduled events for the user; and determine a current event from the database of scheduled events, the current event corresponding with a current time and date; and a scheduler coupled to the indoor positioning service and the database interface, to: determine that the location of the user device does not correspond with a location of the current event; determine whether the user is attending a conflicting event; and provide a notification to the user or a meeting organizer regarding the current event.

In Example 2, the subject matter of Example 1 optionally includes wherein to determine whether the user is attending the conflicting event, the scheduler is to: determine a second event from the database of scheduled events; and determine that the location of the user device corresponds with a location of the second event.

In Example 3, the subject matter of any one or more of Examples 1-2 optionally include wherein the determination of whether the user is attending the conflicting event is negative, and wherein the scheduler is to: determine that the current event has concluded with a period of remaining time; determine that the user is free from any other scheduled event during the period of remaining time; and schedule a new event during the period of remaining time.

In Example 4, the subject matter of Example 3 optionally includes wherein to determine that the current event has concluded, the scheduler is to interface with the indoor positioning service and determine that a location of an attendee from the current event, other than the user, does not correspond with the location of the current event after the location of the attendee had previously corresponded with the location of the current event.

In Example 5, the subject matter of any one or more of Examples 3-4 optionally include wherein to schedule the new event, the scheduler is to: identify the new event from the database of scheduled events, wherein the new event has a duration less than or equal to the an amount of free time the user has before a next scheduled event; and tentatively schedule the new event before the next scheduled event.

In Example 6, the subject matter of any one or more of Examples 1-5 optionally include wherein the determination of whether the user is attending the conflicting event is negative, and wherein the scheduler is to reschedule the current event.

In Example 7, the subject matter of any one or more of Examples 1-6 optionally include wherein the indoor positioning technique includes a wireless network-based technique.

In Example 8, the subject matter of Example 7 optionally includes wherein the wireless network-based technique includes a wireless signal fingerprint technique.

In Example 9, the subject matter of any one or more of Examples 7-8 optionally include wherein the wireless network-based technique includes a trilateration calculated on signal strengths of a plurality of wireless network transmitters.

In Example 10, the subject matter of any one or more of Examples 7-9 optionally include wherein the wireless network-based technique includes a beaconing technique.

In Example 11, the subject matter of Example 10 optionally includes wherein the beaconing technique includes Bluetooth beaconing.

In Example 12, the subject matter of any one or more of Examples 1-11 optionally include a supplemental location service to use a second technique to the indoor positioning service to determine the location of the user device.

In Example 13, the subject matter of Example 12 optionally includes wherein to use the second technique, the supplemental location service is to:

implement a device-to-device network to identify a second possible location of the user device; and validate the location of the user device with the second possible location of the user device.

In Example 14, the subject matter of Example 13 optionally includes wherein the device-to-device network includes a mesh network of the user device and at least one other user device, the at least one other user device communicatively connected to the server system and able to provide a proximity indication of the user device.

Example 15 is a method of providing a meeting attendance tracking system, the method comprising: determining, by a server system implementing an indoor positioning technique, a location of a user device, the user device associated with a user, the location of the user device corresponding with a location of the user; accessing a database of scheduled events for the user; determining a current event from the database of scheduled events, the current event corresponding with a current time and date; determining that the location of the user device does not correspond with a location of the current event; determining whether the user is attending a conflicting event; and providing a notification to the user or a meeting organizer regarding the current event.

In Example 16, the subject matter of Example 15 optionally includes wherein determining whether the user is attending the conflicting event comprises: determining a second event from the database of scheduled events; and determining that the location of the user device corresponds with a location of the second event.

In Example 17, the subject matter of any one or more of Examples 15-16 optionally include wherein the determination of whether the user is attending the conflicting event is negative, and wherein the method further comprises: determining that the current event has concluded with a period of remaining time; determining that the user is free from any other scheduled event during the period of remaining time; and scheduling a new event during the period of remaining time.

In Example 18, the subject matter of Example 17 optionally includes wherein determining that the current event has concluded comprises determining that a location of an attendee from the current event, other than the user, does not correspond with the location of the current event after the location of the attendee had previously corresponded with the location of the current event.

In Example 19, the subject matter of any one or more of Examples 17-18 optionally include wherein scheduling the new event comprises: identifying the new event from the database of scheduled events, wherein the new event has a duration less than or equal to an amount of free time the user has before a next scheduled event; and tentatively scheduling the new event before the next scheduled event.

In Example 20, the subject matter of any one or more of Examples 15-19 optionally include wherein the determination of whether the user is attending the conflicting event is negative, and wherein the method further comprises rescheduling the current event.

In Example 21, the subject matter of any one or more of Examples 15-20 optionally include wherein the indoor positioning technique includes a wireless network-based technique.

In Example 22, the subject matter of Example 21 optionally includes wherein the wireless network-based technique includes a wireless signal fingerprint technique.

In Example 23, the subject matter of any one or more of Examples 21-22 optionally include wherein the wireless network-based technique includes a trilateration calculated on signal strengths of a plurality of wireless network transmitters.

In Example 24, the subject matter of any one or more of Examples 21-23 optionally include wherein the wireless network-based technique includes a beaconing technique.

In Example 25, the subject matter of Example 24 optionally includes wherein the beaconing technique includes Bluetooth beaconing.

In Example 26, the subject matter of any one or more of Examples 15-25 optionally include using a second technique to the indoor positioning technique to determine the location of the user device.

In Example 27, the subject matter of Example 26 optionally includes wherein using the second technique comprises: implementing a device-to-device network to identify a second possible location of the user device; and validating the location of the user device with the second possible location of the user device.

In Example 28, the subject matter of Example 27 optionally includes wherein the device-to-device network includes a mesh network of the user device and at least one other user device, the at least one other user device communicatively connected to the server system and able to provide a proximity indication of the user device.

Example 29 is at least one machine-readable medium including instructions, which when executed by a machine, cause the machine to perform operations of any of the methods of Examples 15-28.

Example 30 is an apparatus comprising means for performing any of the methods of Examples 15-28.

Example 31 is an apparatus of providing a meeting attendance tracking system, the apparatus comprising: means for determining, by a server system implementing an indoor positioning technique, a location of a user device, the user device associated with a user, the location of the user device corresponding with a location of the user; means for accessing a database of scheduled events for the user; means for determining a current event from the database of scheduled events, the current event corresponding with a current time and date; means for determining that the location of the user device does not correspond with a location of the current event; means for determining whether the user is attending a conflicting event; and means for providing a notification to the user or a meeting organizer regarding the current event.

In Example 32, the subject matter of Example 31 optionally includes wherein the means for determining whether the user is attending the conflicting event comprise: means for determining a second event from the database of scheduled events; and means for determining that the location of the user device corresponds with a location of the second event.

In Example 33, the subject matter of any one or more of Examples 31-32 optionally include wherein the determination of whether the user is attending the conflicting event is negative, and wherein the apparatus further comprises:

means for determining that the current event has concluded with a period of remaining time; means for determining that the user is free from any other scheduled event during the period of remaining time; and means for scheduling a new event during the period of remaining time.

In Example 34, the subject matter of Example 33 optionally includes wherein the means for determining that the current event has concluded comprise means for determining that a location of an attendee from the current event, other than the user, does not correspond with the location of the current event after the location of the attendee had previously corresponded with the location of the current event.

In Example 35, the subject matter of any one or more of Examples 33-34 optionally include wherein the means for scheduling the new event comprise:

means for identifying the new event from the database of scheduled events, wherein the new event has a duration less than or equal to an amount of free time the user has before a next scheduled event; and means for tentatively scheduling the new event before the next scheduled event.

In Example 36, the subject matter of any one or more of Examples 31-35 optionally include wherein the determination of whether the user is attending the conflicting event is negative, and wherein the apparatus further comprises means for rescheduling the current event.

In Example 37, the subject matter of any one or more of Examples 31-36 optionally include wherein the indoor positioning technique includes a wireless network-based technique.

In Example 38, the subject matter of Example 37 optionally includes wherein the wireless network-based technique includes a wireless signal fingerprint technique.

In Example 39, the subject matter of any one or more of Examples 37-38 optionally include wherein the wireless network-based technique includes a trilateration calculated on signal strengths of a plurality of wireless network transmitters.

In Example 40, the subject matter of any one or more of Examples 37-39 optionally include wherein the wireless network-based technique includes a beaconing technique.

In Example 41, the subject matter of Example 40 optionally includes wherein the beaconing technique includes Bluetooth beaconing.

In Example 42, the subject matter of any one or more of Examples 31-41 optionally include means for using a second technique to the indoor positioning technique to determine the location of the user device.

In Example 43, the subject matter of Example 42 optionally includes wherein the means for using the second technique comprise: means for implementing a device-to-device network to identify a second possible location of the user device; and means for validating the location of the user device with the second possible location of the user device.

In Example 44, the subject matter of Example 43 optionally includes wherein the device-to-device network includes a mesh network of the user device and at least one other user device, the at least one other user device communicatively connected to the server system and able to provide a proximity indication of the user device.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A meeting attendance tracking system, the system comprising:
an indoor positioning service coupled to a plurality of radio transmitters, and operable to determine a location of a user device, the user device associated with a user, the location of the user device corresponding with a location of the user;
a database interface to:
access a database of scheduled events for the user; and
determine a current event from the database of scheduled events, the current event corresponding with a current time and date; and
a scheduler coupled to the indoor positioning service and the database interface, to:
determine that the location of the user device does not correspond with a location of the current event;
determine whether the user is attending a conflicting event; and
provide a notification to the user or a meeting organizer regarding the current event.

2. The system of claim 1, wherein to determine whether the user is attending the conflicting event, the scheduler is to:
determine a second event from the database of scheduled events; and
determine that the location of the user device corresponds with a location of the second event.

3. The system of claim 1, wherein the determination of whether the user is attending the conflicting event is negative, and wherein the scheduler is to:
determine that the current event has concluded with a period of remaining time;
determine that the user is free from any other scheduled event during the period of remaining time; and
schedule a new event during the period of remaining time.

4. The system of claim 3, wherein to determine that the current event has concluded, the scheduler is to interface with the indoor positioning service and determine that a location of an attendee from the current event, other than the user, does not correspond with the location of the current event after the location of the attendee had previously corresponded with the location of the current event.

5. The system of claim 3, wherein to schedule the new event, the scheduler is to:
identify the new event from the database of scheduled events, wherein the new event has a duration less than or equal to the an amount of free time the user has before a next scheduled event; and
tentatively schedule the new event before the next scheduled event.

6. The system of claim 1, wherein the determination of whether the user is attending the conflicting event is negative, and wherein the scheduler is to reschedule the current event.

7. The system of claim 1, further comprising:
a supplemental location service to use a second technique to the indoor positioning service to determine the location of the user device.

8. The system of claim 7, wherein to use the second technique, the supplemental location service is to:
implement a device-to-device network to identify a second possible location of the user device; and
validate the location of the user device with the second possible location of the user device.

9. The system of claim 8, wherein the device-to-device network includes a mesh network of the user device and at least one other user device, the at least one other user device communicatively connected to the server system and able to provide a proximity indication of the user device.

10. A method of providing a meeting attendance tracking system, the method comprising:
determining, by a server system implementing an indoor positioning technique, a location of a user device, the user device associated with a user, the location of the user device corresponding with a location of the user;
accessing a database of scheduled events for the user;
determining a current event from the database of scheduled events, the current event corresponding with a current time and date;
determining that the location of the user device does not correspond with a location of the current event;
determining whether the user is attending a conflicting event; and
providing a notification to the user or a meeting organizer regarding the current event.

11. The method of claim 10, wherein determining whether the user is attending the conflicting event comprises:
determining a second event from the database of scheduled events; and
determining that the location of the user device corresponds with a location of the second event.

12. The method of claim 10, wherein the determination of whether the user is attending the conflicting event is negative, and wherein the method further comprises:
determining that the current event has concluded with a period of remaining time;
determining that the user is free from any other scheduled event during the period of remaining time; and
scheduling a new event during the period of remaining time.

13. The method of claim 12, wherein determining that the current event has concluded comprises determining that a location of an attendee from the current event, other than the user, does not correspond with the location of the current event after the location of the attendee had previously corresponded with the location of the current event.

14. The method of claim 12, wherein scheduling the new event comprises:
identifying the new event from the database of scheduled events, wherein the new event has a duration less than or equal to an amount of free time the user has before a next scheduled event; and
tentatively scheduling the new event before the next scheduled event.

15. The method of claim 10, wherein the determination of whether the user is attending the conflicting event is negative, and wherein the method further comprises rescheduling the current event.

16. The method of claim 10, further comprising:
using a second technique to the indoor positioning technique to determine the location of the user device.

17. The method of claim 16, wherein using the second technique comprises:
implementing a device-to-device network to identify a second possible location of the user device; and
validating the location of the user device with the second possible location of the user device.

18. The method of claim 17, wherein the device-to-device network includes a mesh network of the user device and at least one other user device, the at least one other user device communicatively connected to the server system and able to provide a proximity indication of the user device.

19. At least one machine-readable medium including instructions, which when executed by a machine, cause the machine to:
determine, by a server system implementing an indoor positioning technique, a location of a user device, the user device associated with a user, the location of the user device corresponding with a location of the user;
access a database of scheduled events for the user;
determine a current event from the database of scheduled events, the current event corresponding with a current time and date;
determine that the location of the user device does not correspond with a location of the current event;
determine whether the user is attending a conflicting event; and
provide a notification to the user or a meeting organizer regarding the current event.

20. The at least one machine-readable medium of claim 19, wherein the instructions to determine whether the user is attending the conflicting event comprise instructions to:
determine a second event from the database of scheduled events; and
determine that the location of the user device corresponds with a location of the second event.

21. The at least one machine-readable medium of claim 19, wherein the determination of whether the user is attending the conflicting event is negative, and wherein the at least one machine-readable medium further comprises instructions to:
determine that the current event has concluded with a period of remaining time;
determine that the user is free from any other scheduled event during the period of remaining time; and
schedule a new event during the period of remaining time.

22. The at least one machine-readable medium of claim 21, wherein the instructions to determine that the current event has concluded comprise instructions to determine that a location of an attendee from the current event, other than the user, does not correspond with the location of the current event after the location of the attendee had previously corresponded with the location of the current event.

23. The at least one machine-readable medium of claim 21, wherein the instructions to schedule the new event comprise instructions to:
identify the new event from the database of scheduled events, wherein the new event has a duration less than or equal to an amount of free time the user has before a next scheduled event; and
tentatively schedule the new event before the next scheduled event.

24. The at least one machine-readable medium of claim 19, wherein the determination of whether the user is attending the conflicting event is negative, and wherein the at least one machine-readable medium further comprise instructions to reschedule the current event.

25. The at least one machine-readable medium of claim 19, wherein the indoor positioning technique includes a wireless network-based technique.
